(19) United States
(12) Patent Application Publication
(10) Pub. No.: US 2004/0020254 A1
(43) Pub. Date: Feb. 5, 2004

(54) Controlled release fertilizer and method for production thereof

(75) Inventors: Nick P. Wynnyk, Edmonton (CA); Eugene G. Stelmack, Fort Saskatchewan (CA); Nicolette M. Babiak, Gibbons (CA); Leslie L. Carstens, Thorhild (CA); Baozhong Xing, Calgary (CA); Albert J. Geiger, Buck Lake (CA); J. David Eastham, Sherwood Park (CA)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(73) Assignee: Agrium

(21) Appl. No.: 10/210,177

(22) Filed: Aug. 2, 2002

(51) Int. Cl. C05G 5/00

(52) U.S. Cl. 71/64.11

(57) ABSTRACT

A controlled release fertilizer material comprising a particulate plant nutrient surrounded by a coating comprising at least one substantially homogeneous layer of a urethane-containing compound and an organic additive. With appropriate selection of the additive, the shape and duration of the release profile can be modified to suit a wide variety of applications.

### CROSS-REFERENCE TO RELATED APPLICATION

None.

### BACKGROUND OF THE INVENTION

1. Field of the Invention

The present invention relates to a controlled release fertilizer and to a method for production thereof.

2. Description of the Prior Art

Fertilizers have been used for many years to supplement nutrients in growing media.

In recent years the art has focused on techniques to deliver controlled amounts of plant nutrients to the soil or other growing media. This has been done so that, on one hand, the growing plants are not adversely deprived of nutrients and, on the other hand, an over supply of nutrients is avoided. An over supply of nutrients can result in toxicity to the plants or losses from leaching. The resulting improvement in FUE (fertilizer use efficiency) can reduce the rate and the frequency of nutrient application.

U.S. Pat. No. 5,538,531 [Hudson et al. (Hudson)] and the prior art cited therein provides a useful overview of methods of conveying controlled release properties to a particulate plant nutrient. Specifically, Hudson teaches a controlled release, particulate fertilizer product having a water soluble fertilizer central mass encased in a plurality of water insoluble, abrasion resistant coatings. At least one inner coating is a urethane reaction product derived from recited isocyanates and polyols. The outer coating is formed from an organic wax having a drop melting point in the range of from 50° C. to 120° C. The general teachings of Hudson and those of the examples in Hudson make it clear that the Hudson process involves curing the urethane coating(s) around the particulate plant nutrient and, thereafter, applying to the cured urethane coating(s) the outer layer of organic wax.

It is also known in the art to pre-coat particulate plant nutrient (U.S. Pat. No. 6,039,781) with an organic oil and particulate materials as a means to regularize or otherwise improve the release profiles of the particulate plant nutrient.

U.S. Pat. No. 6,358,296 [Markusch et al. (Markusch)] teaches a slow-release polyurethane encapsulated fertilizer using oleo polyols. Specifically, Markusch teaches a process which involves using an isocyanate-reactive component or a polyisocyanate component to fertilizer products to form coated fertilizer products followed by application of the other reactive half of the system to form polyurethane encapsulated fertilizer particles. The purported point of novelty in Markusch is the discovery that the use of oleo polyols leads to the production of a controlled release fertilizer having improved release properties (see Examples 1-4 of Markusch).

Many of the commercial products made with existing technologies such as sulphur coated slow release fertilizers have very fast release rates in the first few days after application, but the release rate then slows down significantly. Polymer coated products such as those of Hudson tend to have slower initial release rates and more linear release profiles. In either case, the duration of release can be shortened by application of a thinner coat (or lengthened by application of a thicker coat).

Other technologies introduce engineered defects or soluble regions into the film to control the release rate of nutrients. By increasing or decreasing the concentration of defects in the coating, the duration of the release period can be increased or decreased.

International patent publication number WO 01/66492 [Pildysh] teaches that introduction of certain particulate fillers into a sulphur matrix can create interfacial passageways that can be used to control the release rate of a nutrient. Adding more or less filler and thus providing more or fewer interfacial passages can affect the duration of the release period.

U.S. Pat. No. 5,009,696 [Fujita et al.] teaches that addition of certain copolymers into a polyolefin film can be used to affect the rate at which fertilizer is released from within a polyolefin coating. The higher the concentration of the copolymer, the faster the rate of release.

U.S. Pat. No. 5,176,734 [Fujita et al.] teaches a method whereby certain materials are added into a polymer coating to affect the rate at which the coating decomposes through microbial action and/or photodecomposition.

U.S. Pat. No. 6,139,597 [Tijsma et al. (Tijsma)] teaches a slow release fertilizer with a Gaussian (“S” or sigmoidal shaped) release pattern useful for nursery stock applications. Preferably the substrate fertilizer to be coated must have a very high proportion (greater than 95%) of particles which are spherical.

Despite these advances in the art, there is still some room for improvement. Specifically, it would be desirable to have a controlled release fertilizer and process for production thereof which would allow for the ready customization of both the duration and shape of the release rate profile of a given particulate plant nutrient having applied thereto a given amount of urethane coating. It would also be desirable to be able to achieve a desirable release rate profile for a given particulate plant nutrient using significantly reduced amounts of coating materials Ideally, it would be desirable to control the rate of nutrient release to the rate at which the crop takes up the nutrient (ie control the shape of the release curve to match the shape of the nutrient uptake curve for the crop being fertilized).

It would be particularly useful to have an approach which obviates the need for a special procedure to account for the fact the most fertilizer substrates have a spherical fraction and non-spherical fraction. In some cases, prior to coating, these fractions are separated to isolate a predominately spherical fraction or the fertilizer substrates are otherwise subject to a special process to deal with this phenomenon—e.g., see Tijsma.

International patent WO 02/00573 [Geiger et al. (Geiger)] teaches a slow-release polyurethane encapsulated fertilizer using polyurethane and wax. Specifically Geiger teaches a process in which wax is in the polyurethane coating, not a separate coating (i.e., as described by Hudson). In Geiger, desired controlled release profiles can be achieved with less coating materials and a relatively simple procedure (see Geiger's Examples 1-3).

The application of the fertilizers has developed to the stage that fertilizers with different nutrients are mixed and blended together to provide balanced nutrients to the plants. The blending process can cause severe damage to the fertilizer coating.

### SUMMARY OF THE INVENTION

It is an object of the present invention to obviate or mitigate at least one of the above-mentioned disadvantages of the prior art.

It is an object of the present invention to provide a novel controlled release fertilizer which obviates or mitigates at least one of the above-mentioned disadvantages of the prior art.

It is another object of the present invention to provide a novel process for producing such a controlled release fertilizer.

Accordingly, in one of its aspects the present invention provides a controlled release fertilizer material comprising a particulate plant nutrient surrounded by a coating which is the reaction product of a mixture comprising: a polyol, an isocyanate and an organic additive.

In another of its aspects, the present invention provides a process for producing a controlled release fertilizer material comprising the steps of:

(a) contacting a particulate plant nutrient with a mixture comprising: a hydrogen-containing compound (e.g., a polyol), an isocyanate and an organic additive to produce a coating surrounding the particulate plant nutrient; and

(b) curing the coating to produce the controlled release fertilizer material.

In yet another of its aspects the present invention provides a controlled release fertilizer material comprising a particulate plant nutrient surrounded by a coating comprising at least one substantially homogeneous layer of a urethane-containing compound and an organic additive.

Thus, we have surprisingly and unexpectedly discovered that an improved controlled release fertilizer material and process for production thereof may be achieved from a coating which is the reaction product of a mixture comprising: a polyol (e.g., castor oil, a polyester polyol, a polyether polyol, an oleo polyol, and the like) or a mixture of polyols, an isocyanate or a mixture of isocyanates, and an organic additive or a mixture of organic additives. Specifically, while it is known to use wax as post-coat after application of the urethane layer, the advantages of incorporating the wax and/or other organic additives with the urethane forming reagents has heretofore been unknown. These advantages include:

(a) the ability to extend the duration of the release period for a given plant nutrient having a given amount of urethane coating thereon;

(b) the ability to achieve a desirable release rate profile using significantly less coating than used with comparable prior art coating techniques;

(c) the ability to coat a particulate substrate comprising both a spherical fraction and a non-spherical fraction without the need to separate the fractions prior to coating;

(d) the ability to produce release profiles of different shapes to match the needs of a wide variety of crops with a single coating process;

(e) the ability to obtain such a product via one-step process (i.e., compared to the multi-step processes of the prior art);

(f) the ability to achieve a desirable controlled release fertilizer with desired release performance, mechanical properties, and economical performance.

Other advantages will become apparent to those of skill in the art having the present specification in hand.

As stated hereinabove, the present controlled release fertilizer material comprises a coating derived from a mixture comprising: a polyol (e.g., castor oil, oleo polyol, polyester polyol, polyether polyol and the like) or a mixture of polyols, an isocyanate or a mixture of isocyanates, and an organic additive or a mixture of organic additives. The polyol and isocyanate are chemically reactive and form a urethane. The organic additive is believed to be physically intermixed with the so-formed urethane i.e., the preferred organic additive for use herein is believed to be substantially chemically inert to the polyol and the isocyanate components. The resultant coating is a substantially homogeneous layer. In other words, unlike the prior art approach taught by Hudson and by others involving multiple, distinct coatings of urethane and wax, the coating produced in the present controlled release fertilizer incorporates urethane and organic additive in at least one substantially homogeneous layer (of course multiple such coatings are contemplated within the scope of the controlled release fertilizer material). In this context, it will be understood that the term “homogeneous” is used in a somewhat broad sense for the purpose of distinguishing a controlled release fertilizer material comprising only distinct layers of urethane and wax (e.g., the fertilizer material taught by Hudson).

As used throughout this specification, the term “urethane-containing compound” is intended to mean a product obtained by reacting a polyol and an isocyanate. Typically, the so-produced compound will be a polyurethane.

As stated hereinabove, the organic additive can be wax, but is not limited to wax. With appropriately selected organic additives, the coated controlled release fertilizer can have different release profiles (curve shapes), better mechanical handling, and, in some cases, a relatively reduced manufacturing cost. With some organic additives, the fertilizer release profiles can substantially complement the nutrient requirements of certain plants. With some organic additives the coating may be stronger and/or tougher and/or more elastic (rubbery) than others, which can meet the mechanical property requirements for the coating. With some organic additive the coating may be more economical.

### BRIEF DESCRIPTION OF THE DRAWINGS

Embodiments of the present invention will be described with reference to the accompanying drawings, wherein like reference numerals denote like parts, and in which:

FIGS. 1-8 illustrate various comparative release profile curves for fertilizer materials produced in the Examples described below.

### DETAILED DESCRIPTION OF THE PREFERRED EMBODIMENTS

Accordingly, in one of its aspects, the present invention relates to a controlled release fertilizer material comprising a particulate plant nutrient surrounded by a coating.

The choice of particulate plant nutrient material useful for the present controlled release fertilizer material is not particularly restricted and is within the purview of a person skilled in the art. Those skilled in the art will recognize that fertilizers with a high degree of sphericity and of a tight size distribution are generally easier to coat. An advantage of the present invention is that, unlike much of the prior art, there is no need to remove particles from the coating process if they are not completely spherical. The present process can be practiced on a substrate which is substantially round. In the present process, there is no requirement for the use of a separation process to remove non-spherical particles from the substrate to be coated. The present process can be used to coat the entire stream as it is produced in a granulator or the like.

The plant nutrient material used may be selected from those disclosed in Hudson and/or Markusch. Preferably, such a plant nutrient comprises a water soluble compound, more preferably a compound containing at least one member selected from the group consisting of nitrogen, phosphorus, potassium, sulfur, micronutrients and mixtures thereof. A preferred such plant nutrient comprises urea. Other useful examples of plant nutrients are taught in U.S. Pat. No. 5,571,303 [Bexton]—e.g., ammonium sulfate, ammonium phosphate and mixtures thereof. Non-limiting examples of useful micronutrients may be selected from the group comprising copper, zinc, boron, manganese, iron and mixtures thereof.

Preferably, the coating surrounds the plant nutrient material in an amount in the range of from about 0.1 to about 10 percent by weight, more preferably from about 0.5 to about 7.0 percent by weight, most preferably from about 0.7 to about 4.0 percent by weight, based on the weight of the plant nutrient material.

The coating is the reaction product of a mixture comprising: a polyol, an isocyanate, and an organic additive.

The choice of polyol is not particularly restricted and is within the purview of a person skilled in the art. For example, the polyol may be a hydroxyl-terminated backbone of a member selected from the group comprising polyether, polyester, polycarbonate, polydiene and -polycaprolactone, or a mixture thereof. Preferably, such a polyol is selected from the group comprising hydroxyl-terminated polyhydrocarbons, hydroxyl-terminated polyformals, fatty acid triglycerides, hydroxyl-terminated polyesters, hydroxymethyl-terminated polyesters, hydroxymethyl-terminated perfluoromethylenes, polyalkyleneether glycols, polyalkylenearyleneether glycols and polyalkyleneether triols. More preferred polyols are selected from the group comprising polyethylene glycols, adipic acid-ethylene glycol polyester, poly(butylene glycol), poly(propylene glycol) and hydroxyl-terminated polybutadiene—see, for example, British patent No. 1,482,213. The most preferred such polyol is a polyether polyol. Preferably, such a polyether polyol has a molecular weight in the range of from about 60 to about 20,000, more preferably from about 60 to about 10,000, most preferably from about 60 to about 8,000.

A particularly preferred class of polyols is that disclosed in Hudson. Preferably, such a polyol comprises from about 2 to about 6 hydroxyl moieties. More preferably, such a polyol comprises at least one C₁₀-C₂₂ aliphatic moiety. Most preferably, the polyol comprises castor oil.

Additionally, the polyol may be derived from natural sources such as soybean, corn, canola, soybean and the like (i.e., to produce naturally occurring modified oils). An example of such a synthetic polyol comprising a canola base is commercially available from Urethane Soy Systems Corp. (Princeton, Ill.).

Another class of polyol useful includes oleo polyols such as those described in Markusch.

A mixture of polyols with a prescribed ratio and molecular weight distribution may be useful, for example, castor oil with ethylene glycol, castor oil with oleo polyol, castor oil with polyethylene glycol, castor oil with polypropylene glycol, polypropylene (or polyethylene) glycol mixture of different end groups and molecular weight.

The isocyanate suitable for used in producing the coating is not particularly restricted and the choice thereof is within the purview of a person skilled in the art. Generally, the isocyanate compound suitable for use may be represented by the general formula:

Q(NCO)ᵢ

wherein i is an integer of two or more and Q is an organic radical having the valence of i. Q may be a substituted or unsubstituted hydrocarbon group (e.g. an alkylene or arylene group). Moreover, Q may be represented by the general formula:

Q¹-Z-Q¹

wherein Q¹ is an alkylene or arylene group and Z is chosen from the group comprising —O—, —O-Q¹-, —CO—, —S—, —S-Q¹-S— and —SO₂—. Examples of isocyanate compounds which fall within the scope of this definition include hexamethylene diisocyanate, 1,8-diisocyanato-p-methane, xylyl diisocyanate, (OCNCH₂CH₂CH₂OCH₂O)₂, 1-methyl-2,4-diisocyanatocyclohexane, phenylene diisocyanates, tolylene diisocyanates, chlorophenylene diisocyanates, diphenylmethane-4,4-diisocyanate, naphthalene-1,5-diisocyanate, triphenylmethane-4,4,4-triisocyanate and isopropylbenzene-alpha-4-diisocyanate.

In another embodiment, Q may also represent a polyurethane radical having a valence of i. In this case Q(NCO)ᵢ is a compound which is commonly referred to in the art as a prepolymer. Generally, a prepolymer may be prepared by reacting a stoichiometric excess of an isocyanate compound (as discussed hereinabove) with an active hydrogen-containing compound (as discussed hereinabove), preferably the polyhydroxyl-containing materials or polyols discussed above. In this embodiment, the polyisocyanate may be, for example, used in proportions of from about 30 percent to about 200 percent stoichiometric excess with respect to the proportion of hydroxyl in the polyol.

In another embodiment, the isocyanate compound suitable for use in the process of the present invention may be selected from dimers and trimers of isocyanates and diisocyanates, and from polymeric diisocyanates having the general formula:

Q(NCO)ᵢ]ⱼ

wherein both i and j are integers having a value of 2 or more, and Q is a polyfunctional organic radical, and/or, as additional components in the reaction mixture, compounds having the general formula:

L(NCO)ᵢ

wherein i is an integer having a value of 1 or more and L is a monofunctional or polyfunctional atom or radical. Examples of isocyanate compounds which fall with the scope of this definition include ethylphosphonic diisocyanate, phenylphosphonic diisocyanate, compounds which contain a ═Si—NCO group, isocyanate compounds derived from sulphonamides (QSO₂NCO), cyanic acid and thiocyanic acid.

See also, for example, British patent No. 1,453,258.

Non-limiting examples of suitable isocyanates include: 1,6-hexamethylene diisocyanate, 1,4-butylene diisocyanate, furfurylidene diisocyanate, 2,4-toluene diisocyanate, 2,6-toluene diisocyanate, 2,4-diphenylmethane diisocyanate, 4,4-diphenylmethane diisocyanate, 4,4-diphenylpropanediisocyanate, 4,4-diphenyl-3,3′-dimethyl methane diisocyanate, 1,5-naphthalene diisocyanate, 1-methyl-2,4-diisocyanate-5-chlorobenzene, 2,4-diisocyanato-s-triazine, 1-methyl-2,4-diisocyanato cyclohexane, p-phenylene diisocyanate, m-phenylene diisocyanate, 1,4-naphthalene diisocyanate, dianisidine diisocyanate, bitoluene diisocyanate, 1,4-xylylene diisocyanate, 1,3-xylylene diisocyanate, bis-(4-isocyanatophenyl)methane, bis-(3-methyl-4-isocyanatophenyl)methane, polymethylene polyphenyl polyisocyanates and mixtures thereof.

A particularly preferred group of isocyanates are those described in Hudson and/or Markusch.

An isocyanate mixture is preferred for some coating properties and process requirements.

Preferably, the polyol and isocyanate are used in amounts such that the ratio of NCO groups in the isocyanate to the hydroxyl groups in the polyol is in the range of from about 0.8 to about 3.0, more preferably from about 0.8 to about 2.0, most preferably from about 0.9 to about 1.1.

The organic additive may be selected from the group consisting of petroleum products (e.g., wax, paraffin oil, bitumen, asphalt, lubricants and the like, including mixtures of two or more of these), coal products (e.g., oil, lubricants, bitumen, and wax and the like, including mixtures of two or more of these), natural products (e.g., canola oil, soybean oil, coconut oil, linseed oil, tung oil, vegetable wax, animal fat, animal wax, forest products, such as tall oil, modified tall oil, tall oil pitch, pine tar, and the like, including mixtures of two or more of these) and synthetic products (e.g., synthetic oils, waxes, polymers, lubricants and the like, including mixtures of two or more of these). Mixtures of materials from two or more different classes are also suitable (e.g., a mixture of bitumen and tall oil), and may be available as by-products from other industrial processes.

If the organic additive used is a wax, the wax suitable for use in the mixture to produce the coating may be selected from those described in Hudson and from silicon waxes (commercially available from Dow Corning). Thus, the preferred wax comprises a drop melting point of at least about 30° C., preferably in the range of from about 40° C. to about 120° C., more preferably in the range of from about 50° C. to about 120° C. More preferably, the wax is substantially non-tacky below a temperature of about 40° C. The preferred wax comprises a C₂₀₊ alpha olefin, more preferably a C₂₀₋₁₀₀ alpha olefin.

Preferably, the organic additive is present in the mixture in an amount of up to about 80 percent by weight, based on the combined weight of the organic additive and the polyol. More preferably, the organic additive is present in the mixture in an amount in the range of from about 1.0 to about 50 percent by weight, based on the combined weight of the organic additive and the polyol. Most preferably, the organic additive is present in the mixture in an amount in the range of from about 2.0 to about 35 percent by weight based, on the combined weight of the organic additive and the polyol.

Step (a) in the present process comprises contacting a particulate plant nutrient with a mixture comprising: a polyol, an isocyanate and an organic additive to produce a coating surrounding the particulate plant nutrient. The precise mode of applying the mixture to the plant nutrient is not particularly restricted—see, for example, column 5 lines 31-63 of Hudson.

Step (b) in the present process comprises curing the mixture of the mixture of polyol and isocyanate to form a polyurethane coating.

In the present process, it is preferred to conduct Step (a) and (b) at a temperature in the range of from about 10° C. to about 180° C., more preferably in the range of from about 20° C. to about 150° C., most preferably in the range of from about 50° C. to about 90° C.

The organic additive can be premixed with the polyol, or isocyanate, or be a separate stream by itself, or all three components can be mixed together into a single stream.

Step (a) can be conducted by applying first the polyol component (with/without organic additive) on the particulate plant nutrient, then the isocyanate component (with/without organic additive). The opposite procedure can be adopted also. A third stream may be used, e.g., the organic additive. The third stream can be in the middle of the first and the second stream or be the last one, or the first one. The order putting these streams in to the system can be any possible combination. These streams may be mixed in a nozzle before entering the coating equipment, may be separately sprayed into the coating equipment and mixed before contact with the fertilizer, or may be mixed on the surface of the fertilizer. There will be no separate layers on the coated fertilizer. Alternatively, a mixture of all components can be applied in one step. Multi-coating can be applied to obtain desired release and mechanical properties.

Preferably, Step (a) comprises contacting the particulate plant nutrient with a first stream comprising the polyol component (with/without organic additive) and a second stream comprising the isocyanate (with/without organic additive), the first stream and the second stream being independent of one another. If the organic additive is not blended into either the polyol or the isocyanate streams, it may be present as a third independent stream. This third stream can be applied between the first and the second stream or it can be the first stream applied or the last stream applied.

More preferably, the first stream comprises a mixture of the polyol and organic additive. In this embodiment, the particulate plant nutrient may be contacted simultaneously with the first stream and the second stream. Alternatively, the particulate plant nutrient may be contacted with the second stream followed by the first stream. In a further preferred embodiment, Steps (a) and (b) of the present process are repeated at least once to produce a controlled release fertilizer material having a plurality of coating layers.

Embodiments of the present invention will be illustrated with reference to the following examples which should not be used to limit or construe the invention.

### EXAMPLE 1

In this Example, a controlled release fertilizer material was prepared according to the teachings of U.S. Pat. No. 5,538,531 [Hudson et al. (Hudson)]. Accordingly, it will be recognized that this Example is provided for comparative purposes only and is outside the scope of the present invention.

The apparatus used in this Example was capable of applying coating components to a 7.5 kg batch. The apparatus consisted of a Plexiglas horizontal drum 16 inches in diameter and 20 inches in length. The drum end plates had a central 5 inch hole through which the coating components and the substrate are added. The drum internals consisted of four substantially evenly spaced longitudinal baffles, each baffle being about 1 inch in height. The drum was rotated at 75 fpm peripheral speed or about 18 rpm using a Separ™, variable speed drive, horizontal drum roller. The internal temperature of the drum and substrate was maintained at about 75° C. using variable setting electric heating guns. The heating guns were positioned to direct hot air through the holes in the drum end plates.

The coating components were added at a substantially consistent rate using individual Masterflex™ peristaltic pumps and a modified Amacoil™ Machinery auto-sampler. The sampler portion was removed and an individual stainless steel tube for each component was attached to the drive assembly. This allowed the coating components to be distributed the full length of the drum at a substantially constant travel speed.

The substrate used in this Example was commercially available granulated urea (46-0-0). This substrate had a SGN (Size Guide Number) of 240. The substrate (7.5 kg) was preheated in an oven to about 75° C. and was allowed to roll in the coating drum until the temperature had stabilized to 75° C.

The polyol used in this Example was commercially available castor oil in an amount of 42.95 g. The isocyanate used in this Example was polymeric diphenylmethane diisocyanate (BASF PAPI No. 17) in an amount of 19.52 g. The two components are simultaneously added to the coating apparatus through individual lines or pipettes near the top of the rolling bed. The 2.5 weight percent coat was applied to the substrate in three substantially equal layers with about six minutes between application of each layer i.e., the weight of the total coat was 2.5 weight percent based on the weight of the substrate.

A C₃₀₊ alpha olefin wax commercially available from Chevron Phillips Chemical Company was pre-heated to about 150° C. and then was applied in a single layer to the urethane coated substrate. The wax was used in an amount to provide a weight of 1.5 weight percent based on the weight of the substrate. Six minutes after the wax was applied, the drum and contents are cooled with a controlled stream of pressurized air to about 35° C.

Thus, in this Example, the sum of the urethane coat and the wax layer was 4 weight percent based on the weight of the substrate.

A paint shaker simulation test is conducted to evaluate the mechanical handling durability.

The “paint shaker simulation” test used to simulate the damage to the controlled release coating is conducted in a paint shaker machine. First 200 grams of the controlled release fertilizer are placed in a 6″ diameter by 5.5″ deep metal can with lid. Then 8 (1/4 inch by ½ inch) machine bolts with slotted heads and 8 (1/4 inch) square head nuts are added in the can. The can with the controlled release fertilizer, nuts, and bolts is then placed securely in a paint conditioner/shaker (Red Devil, ¼ H.P. model). The test sample is vigorously conditioned in the paint shaker at frequency of 730 cycles per minutes for 6 minutes. The operating time is controlled with an electronic timer (Gralab model 451) that automatically stops the paint shaker at the preset time. After the paint shaker cycling is complete the can is removed and the nuts and bolts are removed by passing the contents through a 3½ mesh screen. The controlled release fertilizer is collected in a pan and returned to its sample bag for the release rate analysis.

A comparison test has been conducted to correlate the simulation effect of the paint shaker with the damage in some commercial fertilizer blenders. The operating time of the paint shaker and the number of the bolts and nuts are determined based on the comparison test. The presetting of these parameters in the test for the work in this patent can simulate properly the damage in the commercial fertilizer blenders.

A comparison test has been conducted between the paint shaker test and the drop test from 20 feet high three times. The damage from the paint shaker is approximately double of that from the 20-foot drop simulation. It is recognized that the paint shaker test is a severe test compared to those cited in other patents, but better reflects actual handling induced damage.

The water release rate profile for the controlled release fertilizer material before and after the paint shaker simulation test was then determined. In the analysis, a Technicon AutoAnalyzer™ was calibrated and used pursuant to the teachings of Automated Determination of Urea and Ammoniacal Nitrogen (University of Missouri, 1980). The following procedure was used:

1. Accurately weigh 15 grams (±0.1 mg) of the sample into a weigh dish. Record the weight of sample. Transfer the sample to 125 mL Erlenmeyer flask.

2. Add 75 mL of demineralized water and stopper the flask.

3. Gently swirl the sample and water until all the particles are submersed.

4. Let the sample stand for a specified time at a constant temperature (typically at room temperature).

5. Gently swirl the flask to mix the solution and decant only the solution to a 100 mL volumetric flask.

6. Rinse the sample with demineralized water adding to the volumetric flask.

7. Bulk to volume of volumetric flask and mix thoroughly.

8. If the test is to be repeated for another time period, repeat starting at Step 2.

9. Once the Technicon AutoAnalyzer II is on line, transfer some of this solution (or perform the required dilutions if necessary) to the Technicon sample cups for analysis.

10. Record the results as parts per million N—NH₃ (read directly from a Shimadzu Integrator).

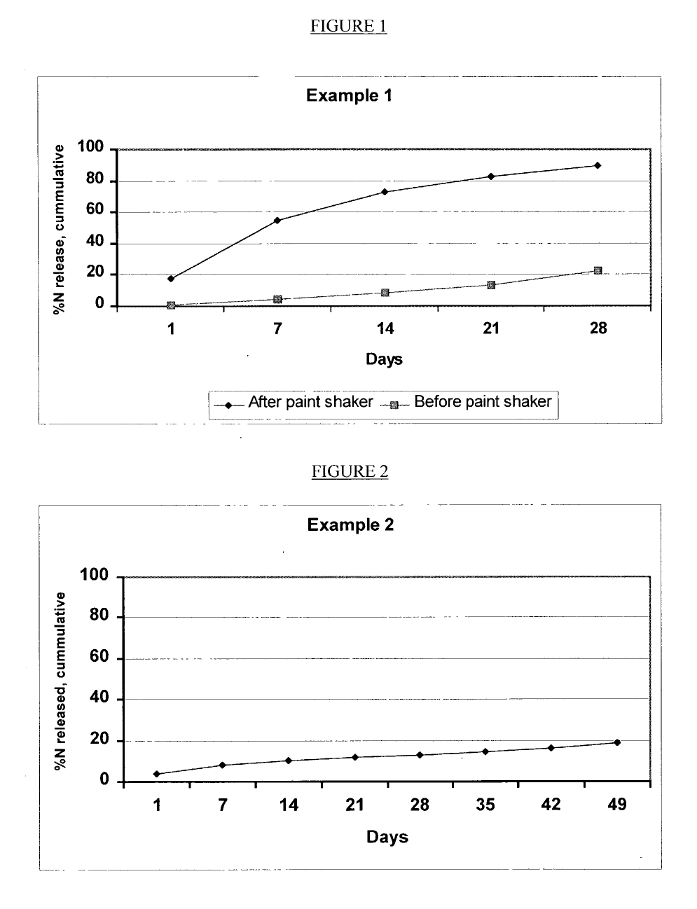

The results of the water release test for the product produced in this Example are shown in FIG. 1.

### EXAMPLE 2

In this Example, a controlled release fertilizer was prepared in accordance with the present invention, using a synthetic oleo polyol derived from soybean oil (Soypolyol 180), containing an OH Value of 180.

The apparatus used to apply the coating components was a stainless steel horizontal insulated drum having a 12-inch diameter a 5½ inches in width. An enclosed back plate was attached to a variable speed drive. The front plate had a central 8-inch opening through which the substrate and the coating components are added. The drum internals consist of four substantially evenly spaced longitudinal baffles, each about 1/2 inch high. The drum was rotated at 75 fpm peripheral speed or about 24 rpm. The internal temperature of the drum and substrate was maintained at about 75° C. using a variable setting electric heating gun. The coating components are added using individual automatic macro pipettes capable of adding one third the weight of each coating component in a single addition.

A 1 kg charge of urea fertilizer at 75° C. was coated as follows: 3 layers, each comprised of first applying a mixture of 1.20 gms C₃₀₊ wax (comprising more than 30 carbons in the molecule) in 4.81 gms Soypolyol 180 at 115C and 2.32 gms of isocyanate. 6 Minutes was allowed between applications of each layer. A total coat wt. of 2.5% was obtained.

The water release rate profile for the controlled release fertilizer material was then determined using the test procedure described above in Example 1. The results are shown in FIG. 2.

### EXAMPLE 3

In this Example, a controlled release fertilizer was prepared in accordance with the present invention, using an asphalt containing oil in place of the C₃₀₊ wax.

As in Example 2, a 1 kg charge of urea fertilizer at 75° C. was coated as follows: 3 layers, each comprised of first applying a mixture of 1.97 gms of asphalt containing oil in 5.91 gms castor oil at 115° C. and 2.95 gms of isocyanate. 6 Minutes was allowed between applications of each layer. A total coat wt. of 3.25% was obtained.

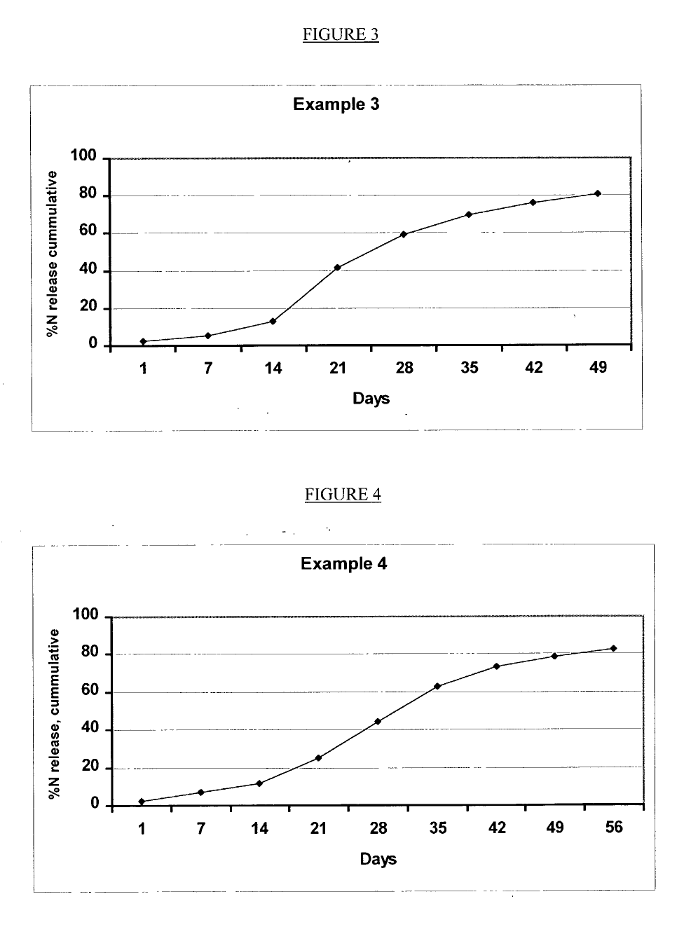

The water release rate profile for the controlled release fertilizer material was then determined using the test procedure described above in Example 1. The results are shown in FIG. 3.

### EXAMPLE 4

In this Example, a controlled release fertilizer was prepared in accordance with the present invention, using heavy petroleum oil in place of the C₃₀₊ wax.

As in Example 3, a 1 kg charge of urea fertilizer at 75° C. was coated as follows: 3 layers, each comprised of first applying a mixture of 0.73 gms of a heavy petroleum oil in 6.54 gms castor oil at 115° C. and 2.73 gms of isocyanate. 6 Minutes was allowed between applications of each layer. A total coat wt. of 3.0% was obtained.

The water release rate profile for the controlled release fertilizer material was then determined using the test procedure described above in Example 1. The results are shown in FIG. 4.

### EXAMPLE 5

In this Example, a controlled release fertilizer was prepared in accordance with the present invention, using a petrolatum (Witco Tech Pet P) in place of the C₃₀₊ wax.

As in Example 3, a 1 kg charge of urea fertilizer at 75° C. was coated as follows: 3 layers, each comprised of first applying a mixture of 0.60 g of a petrolatum (Witco Tech Pet P) in 5.44 g castor oil at 115° C. and 2.29 g of isocyanate. 6 Minutes was allowed between applications of each layer. A total coat wt. of 2.5% was obtained.

The water release rate profile for the controlled release fertilizer material was then determined using the test procedure described above in Example 1. The results are shown in FIG. 5.

### EXAMPLE 6

In this Example, two controlled release fertilizers were prepared in accordance with the present invention, using alternate isocyanates. Specifically, Rubinate 9424 (Huntsman) and Lupranate M10 (BASF) were used.

For both materials in this Example, the coating procedure used was that described above in Example 5. The final coating on both products was comprised of 10% C₃₀₊ wax (based on the total weight of wax and polyol). The total weight of the coating was 2.5%.

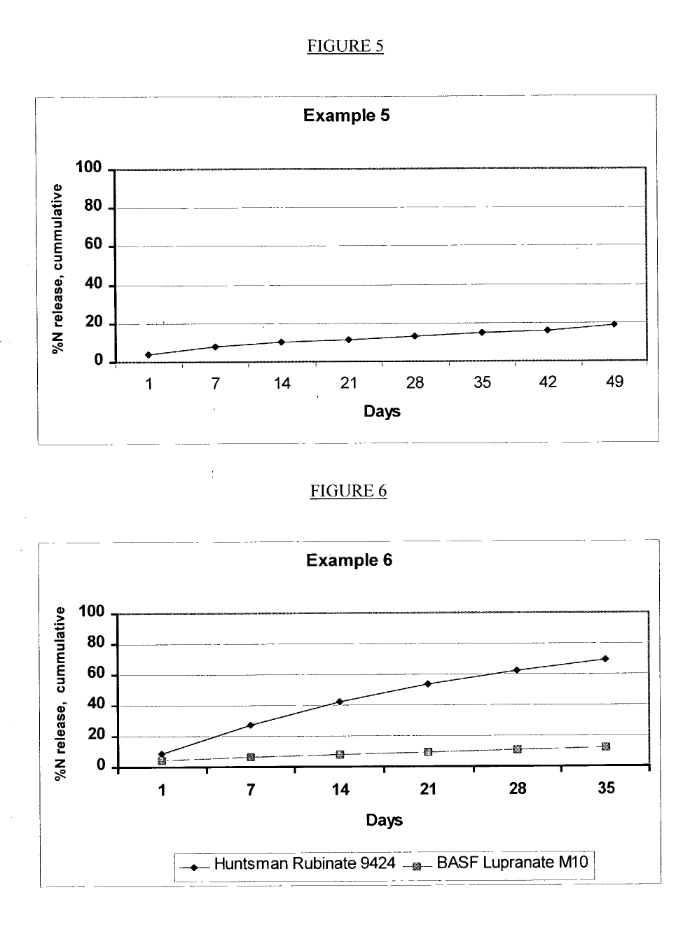

The water release rate profile for the controlled release fertilizer materials was then determined using the test procedure described above in Example 1. The results are shown FIG. 6.

### EXAMPLE 7

In this Example, a controlled release fertilizer was prepared in accordance with the present invention, using different kinds of organic additives, both available from the Chevron Phillips Chemical Company. C₃₀₊ and C₃₀₊HA (comprising narrow carbon number distribution and more alpha olefin compared to C₃0+).

The coating procedure used was that described above in Example 5. The final coating was comprised of 10% C₃₀+wax (based on the total weight of wax and polyol). The total weight of the coating was 4%.

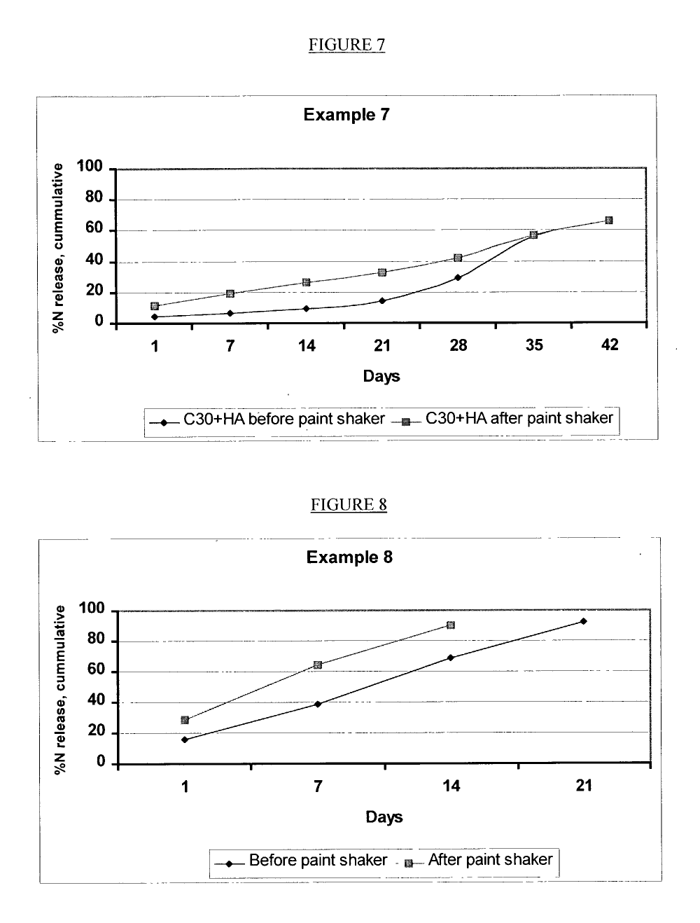

The water release rate profile for the controlled release fertilizer material was then determined using the test procedure described above in Example 1. The results are shown in FIG. 7.

### EXAMPLE 8

In this Example, a controlled release fertilizer was prepared in accordance with the present invention, using an asphalt containing oil in place of the C₃₀₊ wax.

As in Example 2, a 1 kg charge of urea fertilizer at 75° C. was coated as follows: 3 layers, each comprised of first applying a mixture of 2.1 gms of asphalt containing oil in 6.3 gms castor oil at 115° C. and 2.43 gms of isocyanate. Six minutes was allowed between applications of each layer. A total coat wt. of 3.25% was obtained.

The water release rate profile for the controlled release fertilizer material was the determined using the test procedure described above in Example 1. The results are shown in FIG. 8.

As shown in the release rate profiles illustrated in FIGS. 2-8, the present invention can be advantageously utilized to achieve good release profiles with a wide selection range of raw materials. Advantageously, the present invention can be used to produce a controlled release fertilizer material having a prescribed release profile (e.g., a release profile which substantially complements the nutrient uptake profile of a crop or plant of interest). For example, the profiles illustrated in FIGS. 2-8 have a relatively low “start” (as indicated by day 1 and day 7 cumulative release values), thereby advantageously distinguishing these products from the products of the prior art discussed above.

Examples 2, 5 and 8 illustrate the production of products that have a relatively slow, linear release curves but made with different organic additives and polyols. Example 6 also results in production of relatively linear release curves, but through selection of the isocyanate, the duration of the release period has been significantly altered. Linear release curves such as these are most suitable for turf or other crops which require uniform nutrient supply over a growing season.

Examples 3 and 4 illustrate products that release slowly in the initial portion of the release curve but which then have a region where the rate of release increases rapidly. These release curves are generally referred to as having an “S” shaped release profile. Such a profile is more suited to corn and other crops which are easily damaged by excess fertilizer levels in the early stages of growth, yet which need rapid supply of nutrients in approximately the middle third of the growing season. The slope and the acceleration start time of the release profiles can be changed by the selection of the raw materials and the thickness of the coating. Customized supply rate of nutrients to the the plants can be achieved with these selections. These are significant advantages of the present invention.

The mechanical handling properties can be improved (Example 7 and 8) by the correct selection of the raw materials and their ratios. In Example 7, the wax has narrow carbon distribution range and more alpha olefin. After the paint shaker test, an acceptable release profile is obtained. Example 8 is a fast release formulation. With the asphalt containing oil as organic additive, the release profile after the paint shaker test is still relatively good.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

What is claimed is:

1. A controlled release fertilizer material comprising a particulate plant nutrient surrounded by a polymeric coating which is the reaction product of a mixture comprising an active hydrogen-containing compound, an isocyanate and an organic additive.

2. The controlled release fertilizer defined in claim 1, wherein the active hydrogen-containing compound comprises a polyol or mixture of polyols.

3. The controlled release fertilizer material defined in claim 1, wherein the plant nutrient comprises a water soluble compound.

4. The controlled release fertilizer material defined in claim 3, wherein the water soluble compound comprises a compound containing at least one member selected from the group consisting of nitrogen, phosphorus, potassium, sulfur, micronutrients, and mixtures thereof.

5. The controlled release fertilizer material defined in claim 3, wherein the plant nutrient comprises urea.

6. The controlled release fertilizer material defined in claim 2, wherein the polyol is selected from a group consisting of polyether polyols, polyester polyols, oleo polyols, castor oil and mixtures thereof.

7. The controlled release fertilizer material defined in claim 2, wherein the polyol comprises from about 2 to about 6 hydroxyl moieties.

8. The controlled release fertilizer material defined in claim 2, wherein the polyol comprises castor oil.

9. The controlled release fertilizer material defined in claim 2, wherein the polyol comprises a polyester polyol.

10. The controlled release fertilizer material defined in claim 2, wherein the polyol comprises a polyether polyol.

11. The controlled release fertilizer material defined in claim 2, wherein the polyol comprises an oleo polyol.

12. The controlled release fertilizer material defined in claim 1, wherein the isocyanate is selected from the group consisting of diphenylmethane diisocyanate, toluene diisocyanate, aliphatic isocyantes, derivatives thereof, polymers thereof and mixtures thereof.

13. The controlled release fertilizer material defined in claim 1, wherein the isocyanate contains from about 1.5 to about 3.0 isocyanate groups per molecule.

14. The controlled release fertilizer material defined in claim 1, wherein the isocyanate contains from about 10% to about 50% NCO.

15. The controlled release fertilizer material defined in claim 1, wherein the organic additive is selected from the group consisting of a petroleum product, a coal product, a natural product, a synthetic product and mixtures of two or more of these.

16. The controlled release fertilizer material defined in claim 15, wherein the petroleum product is selected from the group consisting of wax, paraffin oil, bitumen, asphalt, lubricants and mixtures thereof.

17. The controlled release fertilizer material defined in claim 15, wherein the coal product is selected from the group consisting of oil, lubricants, bitumen, wax and mixtures thereof.

18. The controlled release fertilizer material defined in claim 15, wherein the natural product is selected from the group consisting of canola oil, soybean oil, coconut oil, linseed oil, tung oil, vegetable wax, animal fat, animal wax, tall oil, modified tall oil, tall oil pitch, pine tar, and mixtures thereof.

19. The controlled release fertilizer material defined in claim 15, wherein the synthetic product is selected from the group consisting of synthetic oil, wax, polymer, lubricants and mixtures thereof.

20. The controlled release fertilizer material defined in claim 15, wherein the organic additive comprises an organic wax.

21. The controlled release fertilizer material defined in claim 1, wherein the coating is present in an amount in the range of from about 0.1 to about 10 percent by weight based on the weight of particulate plant nutrient.

22. The controlled release fertilizer material defined in claim 1, wherein the coating is present in an amount in the range of from about 0.5 to about 7.0 percent by weight based on the weight of particulate plant nutrient.

23. The controlled release fertilizer material defined in claim 2, wherein the ratio of NCO groups from the isocyanate to the hydroxyl groups in the polyol in the mixture is in the range of from about 0.8 to about 3.0.

24. The controlled release fertilizer material defined in claim 2, wherein the ratio of NCO groups from the isocyanate to the hydroxyl groups in the polyol in the mixture is in the range of from about 0.8 to about 2.0.

25. The controlled release fertilizer material defined in claim 2, wherein the ratio of NCO groups from the isocyanate to the hydroxyl groups in the polyol in the mixture is in the range of from about 0.9 to about 1.1.

26. The controlled release fertilizer material defined in claim 1, wherein the amount of organic additive in the mixture is up to about 80 percent by weight based on the combined weight of the organic wax and the polyol.

27. The controlled release fertilizer material defined in claim 1, wherein the amount of organic additive in the mixture is in the range of from about 1.0 to about 50 percent by weight based on the combined weight of the organic additive and the polyol.

28. The controlled release fertilizer material defined in claim 1, wherein the amount of organic additive in the mixture is in the range of from about 2.0 to about 35 percent by weight based on the combined weight of the organic additive and the polyol.

29. A process for producing a controlled release fertilizer material comprising the step of contacting a particulate plant nutrient with an active hydrogen-containing compound, an isocyanate and an organic additive to form a coating which substantially surrounds the particulate plant nutrient.

30. The process defined in claim 29, wherein the particulate material is agitated during the contacting step.

31. The process defined in claim 29, wherein the contacting step is conducted at a temperature in the range of from about 10° C. to about 180° C.

32. The process defined in claim 29, wherein the contacting is conducted at a temperature in the range of from about 20° C. to about 150° C.

33. The process defined in claim 29, wherein contacting step is conducted at a temperature in the range of from about 50° C. to about 90° C.

34. The process defined in claim 29, comprising the steps of:
(a) contacting a particulate plant nutrient with a mixture comprising: a polyol, an isocyanate and an organic additive to produce a coating surrounding the particulate plant nutrient; and
(b) curing the coating to produce the controlled release fertilizer material.

35. The process defined in claim 34, wherein the contacting step comprises contacting the particulate plant nutrient with a first stream comprising the polyol and a second stream comprising the isocyanate, the first stream and the second stream being independent of one another.

36. The process defined in claim 35, wherein the organic additive is present in one or both of the first stream and the second stream.

37. The process defined in claim 34, wherein the contacting step comprises contacting the particulate plant nutrient with a first stream comprising the polyol, a second stream comprising the isocyanate and a third stream comprising the organic additive, the first stream, the second stream and third stream being independent of one another.

38. The process defined in claim 35, wherein the first stream comprises a mixture of the polyol and the organic additive.

39. The process defined in claim 34, wherein Step (a) comprises contacting the particulate plant nutrient simultaneously with the first stream and the second stream.

40. The process defined in claim 34, wherein Step (a) comprises contacting the particulate plant nutrient with the first stream followed by the second stream.

41. The process defined in claim 34, wherein Step (a) comprises contacting the particulate plant nutrient with the second stream followed by the first stream.

42. The process defined in claim 34, wherein Step (a) comprises contacting the particulate plant nutrient with a single stream comprising the polyol, the isocyanate and an organic additive.

43. The process defined in claim 34, wherein Steps (a) and (b) are repeated at least once to produce a controlled release fertilizer material having a plurality of coating layers.

44. The process defined in claim 29, wherein the plant nutrient comprises a water soluble compound.

45. The process defined in claim 29, wherein the water soluble compound comprises a compound containing at least one member selected from the group consisting of nitrogen, phosphorus, potassium, sulphur, micronutrients and mixtures thereof.

46. The process defined in claim 29, wherein the plant nutrient comprises urea.

47. The process defined in claim 29, wherein the polyol is selected from a group consisting of polyether polyols, polyester polyols, oleo polyols, castor oil and mixtures thereof.

48. The process defined in claim 34, wherein the polyol comprises from about 2 to about 6 hydroxyl moieties.

49. The process defined in claim 34, wherein the polyol comprises at least one C₁-C₂₂ aliphatic moiety.

50. The process defined in claim 34, wherein the polyol comprises castor oil.

51. The process defined in claim 34, wherein the polyol comprises a polyester polyol.

52. The process defined in claim 34, wherein the polyol comprises a polyether polyol.

53. The process defined in claim 34, wherein the polyol comprises an oleo polyol.

54. The process defined in claim 29, wherein the isocyanate is selected from the group consisting of diphenylmethane diisocyanate, toluene diisocyanate, aliphatic isocyanates derivatives thereof, polymers thereof and mixtures thereof.

55. The process defined in claim 29, wherein the isocyanate contains from about 1.5 to about 3.0 isocyanate groups per molecule.

56. The process defined in claim 29, wherein the isocyanate contains from about 10% to about 50% NCO.

57. The process defined in claim 29, wherein the isocyanate comprises polymeric diphenylmethane diisocyanate.

58. The process defined in claim 29, wherein the organic additive is selected from the group consisting of petroleum products, coal products, natural products and synthetic products.

59. The process defined in claim 58, wherein the petroleum product is selected from the group consisting of wax, paraffin oil, bitumen, asphalt, lubricants and mixtures thereof.

60. The process defined in claim 58, wherein the coal product is selected from the group consisting of oil, lubricants, bitumen, wax and mixtures thereof.

61. The process defined in claim 58, wherein the natural product is selected from the group consisting of canola oil, soybean oil, coconut oil, linseed oil, tung oil, vegetable wax, animal fat, animal wax, tall oil, modified tall oil, tall oil pitch, pine tar, and mixtures thereof.

62. The process defined in claim 58, wherein the synthetic product is selected from the group consisting of synthetic oil, wax, polymer, lubricants and mixtures thereof.

63. The process defined in claim 58, wherein the organic additive comprises a wax.

64. The process defined in claim 29, wherein the mixture is used in an amount to provide a coating in an amount in the range of from about 0.1 to about 10 percent by weight based on the weight of particulate plant nutrient.

65. The process defined in claim 29, wherein the mixture is used in an amount to provide a coating in an amount in the range of from about 0.5 to about 7.0 percent by weight based on the weight of particulate plant nutrient.

66. The process defined in claim 34, wherein the ratio of NCO groups from the isocyanate to the hydroxyl groups in the polyol in the mixture is in the range of from about 0.8 to about 3.0.

67. The process defined in claim 34, wherein the ratio of NCO groups from the isocyanate to the hydroxyl groups in the polyol in the mixture is in the range of from about 0.8 to about 2.0.

68. The process defined in claim 34, wherein the ratio of NCO groups from the isocyanate to the hydroxyl groups in the polyol in the mixture is in the range of from about 0.9 to about 1.1.

69. The process defined in claim 34, wherein the amount of organic additive in the mixture is up to about 80 percent by weight based on the combined weight of the organic additive and the polyol.

70. The process defined in claim 29, wherein the amount of organic additive in the mixture is in the range of from about 1.0 to about 50 percent by weight based on the combined weight of the organic additive and the polyol.

71. The process defined in claim 29, wherein the amount of organic additive in the mixture is in the range of from about 2.0 to about 35 percent by weight based on the combined weight of the organic additive and the polyol.

72. A controlled release fertilizer material comprising a particulate plant nutrient surrounded by a coating comprising at least one substantially homogeneous layer of a urethane-containing compound and an organic additive.
